(19) United States
(12) Patent Application Publication
(10) Pub. No.: US 2015/0301267 A1
(43) Pub. Date: Oct. 22, 2015

(54) ANAMORPHIC OPTICAL PACKAGE

(71) Applicant: 3M INNOVATIVE PROPERTIES COMPANY, Saint Paul, MN (US)

(72) Inventors: Andrew J. Ouderkirk, St. Paul, MN (US); Max Powers, Minneapolis, MN (US); Nicholas T. Gabriel, St. Louis Park, MN (US); Erin A. McDowell, Afton, MN (US); Michael F. Weber, Shoreview, MN (US)

(21) Appl. No.: 14/648,516

(22) PCT Filed: Dec. 5, 2013
(86) PCT No.: PCT/US13/73305

§ 371 Date: May 29, 2015

Related U.S. Application Data
(60) Provisional application No. 61/733,655, filed on Dec. 5, 2012.

(51) Int. Cl. F21V 8/00; G02B 27/09

(52) U.S. Cl. CPC G02B 6/0061; G02B 6/005; G02B 6/0055; G02B 6/0081; G02B 6/0073; G02B 6/0068; G02B 27/0911; G02B 6/0028

(57) ABSTRACT

An optical package comprises a light source generating light having a first aspect ratio, an anamorphic light guide to receive the light from the light source, a diverter array to receive and divert light from the anamorphic light guide, and a concentrator to collect light received from the diverter array, wherein the concentrator outputs light having a second aspect ratio, the second aspect ratio being greater than the first aspect ratio. An effective height of the output beam is lower than an effective height of the light source.

### THE FIELD OF THE INVENTION

The present invention relates generally to a optical package and more specifically to an LED-based optical package having an anamorphic light guide, a diverter, and a concentrator to provide a thin, efficient, and modular optical package.

### BACKGROUND OF THE INVENTION

Light guides are used in conjunction with light sources, such as light emitting diodes (LEDs), for a wide variety of lighting applications. In one particular application, light guides are commonly used to provide illumination for LCD displays. The light source(s) typically emit light into the light guide, particularly in cases where a very thin profile backlight is desired, as in laptop computer displays. The light guide is a clear, solid, and relatively thin plate whose length and width dimensions are on the order of the backlight output area. The light guide uses total internal reflection (TIR) to transport or guide light from the edge-mounted lamps across the entire length or width of the light guide to the opposite edge of the backlight, and a non-uniform pattern of localized extraction structures is provided on a surface of the light guide to redirect some of this guided light out of the light guide toward the output area of the backlight. Such backlights typically also include light management films, such as a reflective material disposed behind or below the light guide, and a reflective polarizing film and prismatic brightness enhancement film(s) (BEF) disposed in front of or above the light guide, to increase on-axis brightness.

Since most commonly used light sources such as LEDs have a relatively large height and wide range of emission angles from the LEDs, the light guide is usually correspondingly thick to efficiently couple light from the LEDs. A conventional illuminating device for a liquid crystal display is described in U.S. Publication No. 2009/0316431. Conventional illumination devices couple light from a source to a planar light guide. The light guide typically is about the same height as the source, since reducing the height of the light guide will reduce the coupling efficiency from the light source to the light guide.

A significant disadvantage of typical film or plate light guides, however, is the mis-match between the small aspect ratio of LEDs and the very high aspect ratio of light guides. LEDs have a typical aspect ratio of about 1:1 to about 4:1, whereas edge light guides can have an aspect ratio from about 20:1 to as much as about 100:1 or more. This mis-match usually results in the light in the light guide having a much higher etendue, also referred to as throughput, than the light emitted from the LEDs. This high etendue in turn ultimately results in brightness enhancement films being required for the light guide. Matching the thickness of the light guide to the LEDs also results in the light within the lightguide having a wide range of angles. Creating TIR for a wide range of angles requires that both major surfaces of the light guide are bounded by air. As a result, the light guide may be thicker than the liquid crystal display module, and the air interfaces may limit certain applications, such as touch and haptic applications.

### SUMMARY

In one exemplary aspect of the invention, an optical package comprises a light source generating light having a first aspect ratio, an anamorphic light guide to receive the light from the light source, a diverter array to receive and divert light from the anamorphic light guide, and a concentrator to collect light received from the diverter array, wherein the concentrator outputs light having a second aspect ratio, the second aspect ratio being greater than the first aspect ratio, wherein an effective height of the output beam is lower than an effective height of the light source.

The above summary of the present invention is not intended to describe each illustrated embodiment or every implementation of the present invention. The figures and the detailed description that follows more particularly exemplify these embodiments.

### BRIEF DESCRIPTION OF THE DRAWINGS

Embodiments of the invention are better understood with reference to the following drawings. The elements of the drawings are not necessarily to scale relative to each other.

FIG. 1A is an isometric view of a optical package according to an aspect of the invention.

FIG. 1B is an exploded view of the optical package of FIG. 1A.

FIGS. 1C-1D are different close up views of the anamorphic light guide element of the optical package according to an aspect of the invention.

FIGS. 1E-1F are different close up views of the diverter and concentrator elements of the optical package according to an aspect of the invention.

FIG. 1G is a front view of the optical package of FIG. 1A.

FIGS. 2A-2D are various isometric views of an optical package according to another aspect of the invention.

FIG. 3 is an isometric view of an optical package according to another aspect of the invention.

FIG. 4 is an isometric view of an optical package according to another aspect of the invention.

FIG. 5 is an isometric view of an optical package according to another aspect of the invention.

FIG. 6 is an isometric view of an optical package according to another aspect of the invention.

FIG. 7 is an isometric view of an optical package according to another aspect of the invention.

FIG. 8 is an isometric view of an optical package according to another aspect of the invention.

FIG. 9 is an isometric view of an optical package according to another aspect of the invention.

FIG. 10 is an isometric view of an optical package according to another aspect of the invention.

FIG. 11 is an isometric view of an optical package according to another aspect of the invention.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the scope of the invention as defined by the appended claims.

### DETAILED DESCRIPTION

In the following Detailed Description, reference is made to the accompanying drawings, which form a part hereof, and in which is shown by way of illustration specific embodiments in which the invention may be practiced. In this regard, directional terminology, such as “top,” “bottom,” “front,” “back,” “leading,” “forward,” “trailing,” etc., is used with reference to the orientation of the Figure(s) being described. Because components of embodiments of the present invention can be positioned in a number of different orientations, the directional terminology is used for purposes of illustration and is in no way limiting. It is to be understood that other embodiments may be utilized and structural or logical changes may be made without departing from the scope of the present invention. The following detailed description, therefore, is not to be taken in a limiting sense, and the scope of the present invention is defined by the appended claims.

The present invention is directed to a compact, efficient, modular optical package that provides output light with a high aspect ratio and a small effective height. The common elements of the optical package can be configured and arranged to provide a great number of alternative designs that can be implemented in many different ways. As such, the optical package can be used as part of a great number of devices and applications, such as transmissive, transflective, and reflective LCDs (laptops, tablets, cell phones, e-readers, etc.), cholesteric, MEMS, and liquid paper devices, signage and conformable graphics, and indicators, such as vehicular displays.

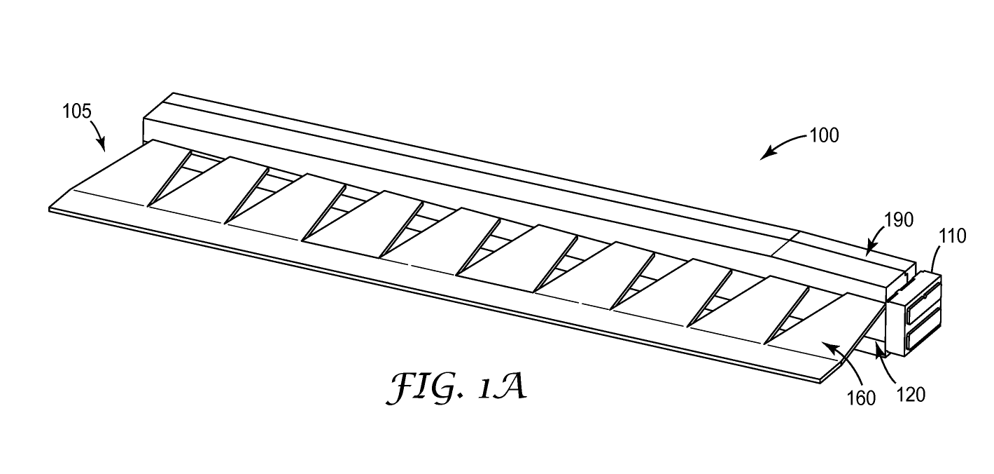

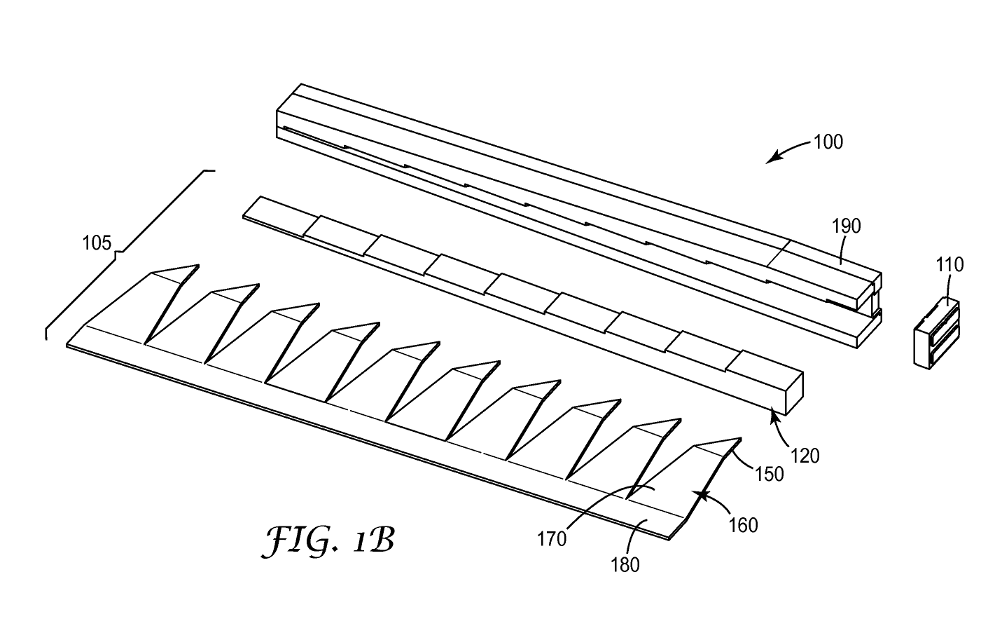

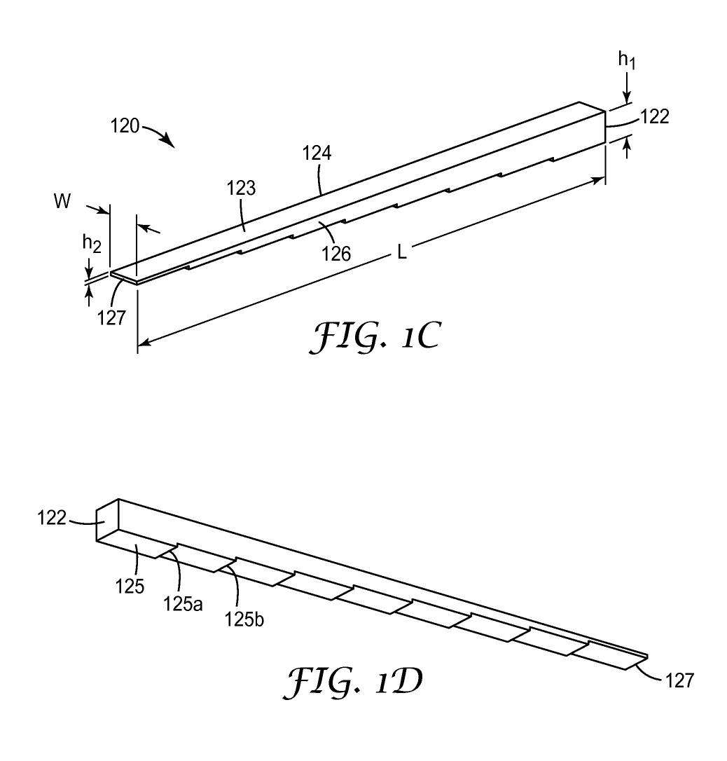

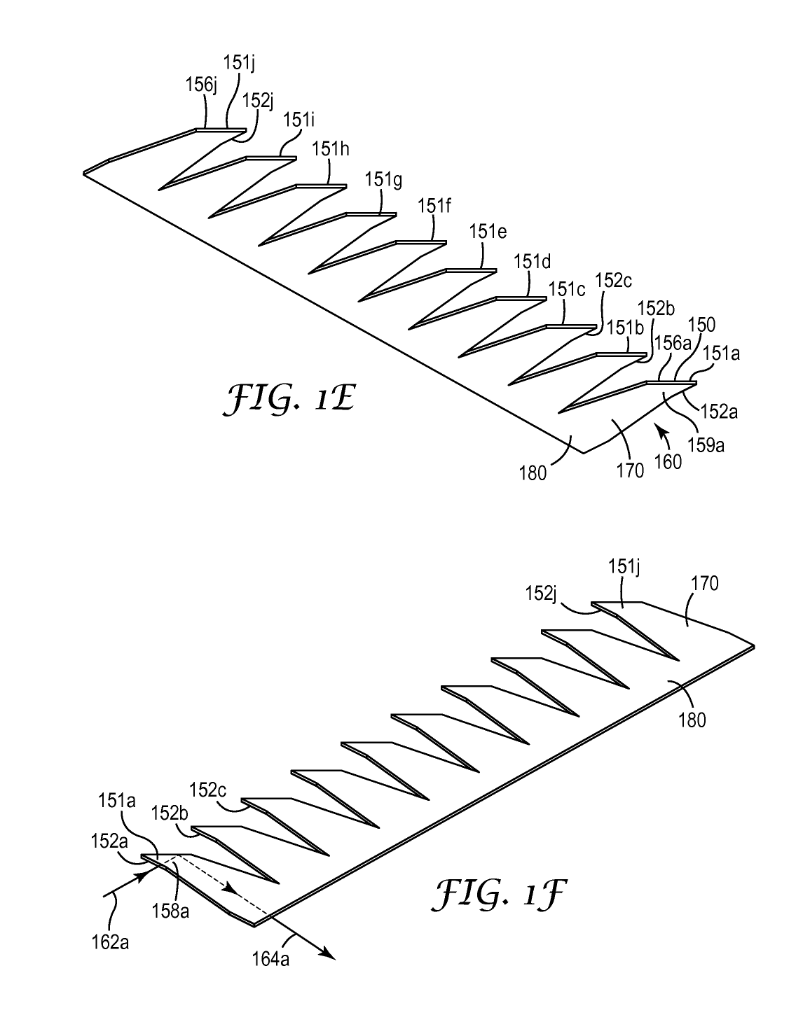

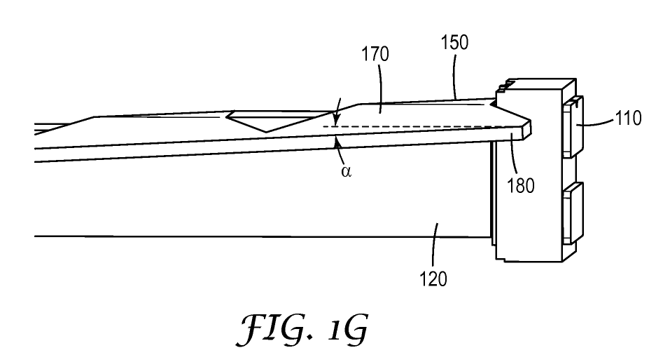

FIG. 1A shows an isometric view of an exemplary optical package 100 that can be used to illuminate a display (not shown), such as an LCD. FIG. 1B shows an exploded view of optical package 100. Optical Package 100 includes a light source unit 110, a converter unit 105, and a housing 190. Light source unit 110 provides a source of light for the optical package 100. Converter unit 105, shown in more detail herein, includes an anamorphic light guide 120 that guides the light from light source unit 110 into a diverter/concentrator element 160. The diverter/concentrator element 160 includes a diverter portion which receives and diverts segments of the light guided by the anamorphic light guide 120 into a coupling portion 170. Light is further directed through the coupling portion 170 into a concentrator portion 180 of the diverter/concentrator element 160. The system 100 efficiently couples light from the light source and provides output light with a larger aspect ratio that can be optionally partially collimated in at least one axis. In addition, the effective height of the output light is substantially lower than the effective height of the light emitted from the light source.

Each of these components will now be described in greater detail.

Source light can be provided by any number of source types, but a more preferred source is an LED-based light source 110. Light source unit 110 can include a single LED, two LEDs, or more LEDs, depending on the type of display being illuminated. The output of the LED(s) 110 may be coupled to the converter unit 105 in a variety of ways. In one example, output light from the light source 110 is directly transmitted into the anamorphic light guide 120 of the converter 105 as substantially non-collimated light. Alternatively, one or more compound parabolic concentrators (CPCs), lenses (not shown), or a combination thereof, can be utilized, depending, e.g., on space requirements, to provide at least some partial beam collimating prior to entering the converter unit 105. If using a CPC, the interior portion of the CPC can either be hollow or made from a transparent material and constructed in the same manner as that of a conventional CPC. Of course, in alternative embodiments, a lens or a multiple lens system can be utilized to collect and collimate the output of the light source 110.

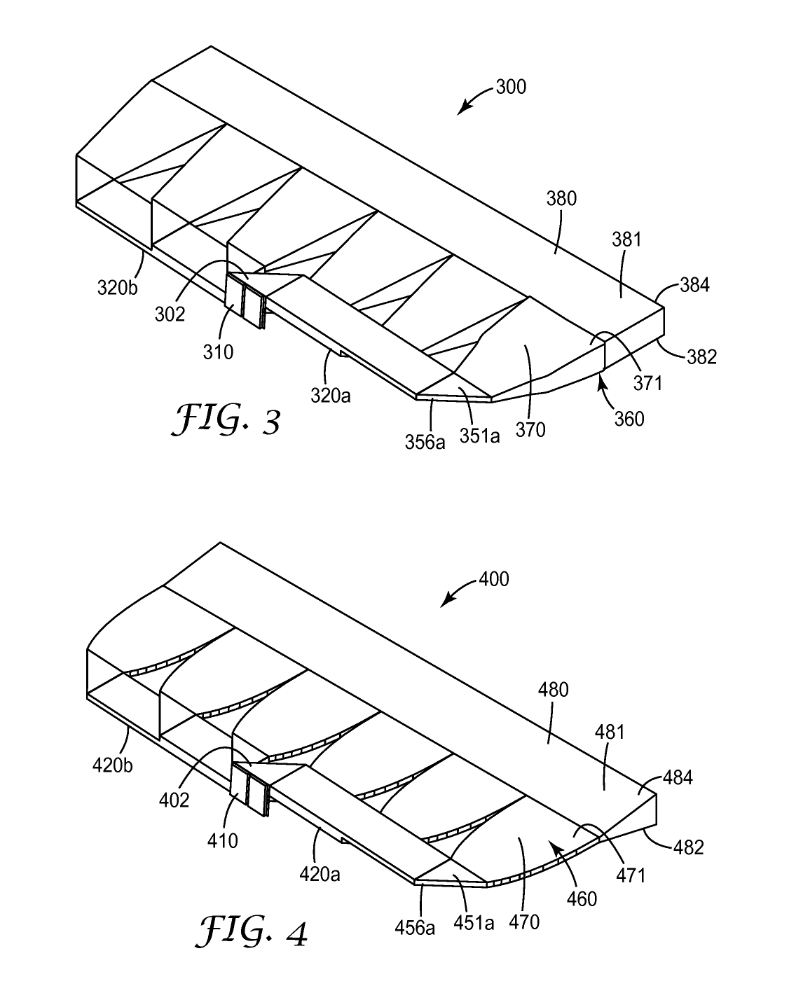

In different aspects of the invention, light source 110 can be positioned at different locations on in the optical system. For example, as shown in FIGS. 1A-1F, light source 110 is positioned at one end of the converter unit 105. Alternatively, such as is shown in FIG. 3, the light source is positioned at a center location along the optical system.

In this regard, “light emitting diode” or “LED” refers to a diode that emits light, whether visible, ultraviolet, or infrared, where the emitted light will have a peak wavelength in a range from about 430 to 700 nm. The term LED includes incoherent light sources that are encased or encapsulated semiconductor devices marketed as “LEDs”, whether of the conventional or super radiant variety, as well as coherent semiconductor devices such as laser diodes, including but not limited to vertical cavity surface emitting lasers (VCSELs). An “LED die” is an LED in its most basic form, i.e., in the form of an individual component or chip made by semiconductor processing procedures. For example, the LED die may be formed from a combination of one or more Group III elements and of one or more Group V elements (III-V semiconductor). Examples of suitable III-V semiconductor materials include nitrides, such as gallium nitride, and phosphides, such as indium gallium phosphide. Other types of III-V materials can also be used, as well as materials from other groups of the periodic table. The component or chip can include electrical contacts suitable for application of power to energize the device. Examples include wire bonding, tape automated bonding (TAB), or flip-chip bonding. The individual layers and other functional elements of the component or chip are typically formed on the wafer scale, and the finished wafer can then be diced into individual piece parts to yield a multiplicity of LED dies. The LED die may be configured for surface mount, chip-on-board, or other known mounting configurations. Some packaged LEDs are made by forming a polymer encapsulant over an LED die and an associated reflector cup. The LED may be grown on one of several substrates. For example, GaN LEDs may be grown by epitaxy on sapphire, silicon, and gallium nitride. An “LED” for purposes of this application should also be considered to include organic light emitting diodes, commonly referred to as OLEDs.

In one aspect of the invention, the light source 110 may comprise an array of two or more different color LEDs, for example red-green-blue (RGB) LEDs (e.g., a red LED in combination with a green LED in combination with a blue LED), or, alternatively, a combination of a red LED with a cyan LED. In another aspect, the LED(s) 110 may comprise one or more remote phosphor LEDs, such as those described in U.S. Pat. No. 7,091,653. In this manner, an appropriate balance of blue and yellow light can create white light.

In another aspect, a blue GaN LED, a YAG phosphor, and collimating optical systems such as lenses and compound parabolic concentrators can be utilized as light source unit 110. An additional illuminator having a different color output can also be used in combination.

Because the system is modular, and a final device can include multiple optical packages 100 positioned throughout the final device, the same or different light sources 110 can be utilized in each optical package module, depending on the application.

In addition, with the design of the system of the present invention, the light source 110 can utilize very high brightness and efficient LEDs, mix and match different discrete colors, and utilize remote phosphor-based LEDs. At the same time, the efficient conversion of light, through the preservation of etendue, can eliminate the need for a large number of LEDs to be utilized.

The light sources may be from a phosphor converted LED or may be a combination of different LEDs. For example, the LEDs may be a combination of a blue LED with a green-emitting phosphor and a red emitting AlInGaP LED. The combination of the anamorphic light guide and the diverters has been found to provide sufficient path length for the light emitted from the LEDs to effectively mix the colors before entering the backlight light guide unit.

In another aspect, the light sources can generate an efficient and uniform RGB color light source for use, e.g., as a backlight for an LCD display.

For example, in one particular aspect, a light source can comprise two independent blue emission flip-chip InGaN LED dies, approximately 500 μm×1000 μm, can be placed on a ˜1 mm² package. One die can include a green phosphor placed on top and the other die can include red phosphor placed on top. The amount of phosphor used on either chip would determine the percentage of conversion of blue light to green or to red light. Using independent dies can allow the power to each chip to be controlled separately, thus offering a method of color tuning. In a further variation, if geometry considerations are taken into account, red light can be sourced from an AlInGaP discrete emitter, thus offering a narrower emission spectrum.

In yet another aspect, a light source can include two independent dies, each approximately 500 μm×1000 μm. The first die can comprise an InGaN die with an emission peak of approx 520 nm to 540 nm. The second die can comprise a blue InGaN emitter with an emission peak of approximately 450 nm to 460 nm. A red phosphor can be placed on the blue emitter. Again, the thickness of the phosphor can determine the percentage of blue light converted to red. With this particular configuration, the use of a green InGaN emitter will offer a narrow emission spectrum relative to the previous configuration. This narrow emission can further improve color gamut for an LCD backlight.

In yet another aspect, a light source can comprise three discrete emitters approximately 300 μm×1000 μm that can be placed on a package having an approximate size of 1 mm². A first emitter can comprise a blue InGaN die with an emission of approximately 450 nm. A second emitter can comprise a green InGaN die with an emission peak of approx 520 nm to 540 nm. A third emitter can comprise an AlInGaP die with an emission peak of approx 630 to 650 nm. This configuration provides a desirable color gamut due to the narrow emission spectra of bare dies. Consideration of the geometry of the wire-bonded AlInGaP die, as well as the control scheme for the three dies, should be taken into account.

Optical package 100 also includes a converter unit 105. The converter unit 105 converts light emitted from the light source 110, which has an aspect ratio of less than about 10:1, such as about 1:1 to about 1:2, into an output light beam having an aspect ratio that is at least twice that of the light source, more preferably at least four times that of the light source, and even more preferably at least five times that of the light source. In some aspects, the converter unit 105 produces a line-shaped output beam. The output beam may be substantially collimated in at least one direction and, in some aspects, can be substantially collimated in two directions. As described another way, the output light from the converter unit 105 has a lower effective height (beam physical height×full-width-half-maximum angle of the light emitted parallel to the height axis) than the effective height of the light output from the light source 110.

One component of converter unit 105 is the anamorphic light guide 120, shown in further detail in FIGS. 1C and 1D. The anamorphic light guide 120 is a generally rectilinear structure having input surface 122, top surface 123, orthogonal surface 124, opposite orthogonal surface 126, bottom surface 125, and end surface 127. Surface 125 comprises a stepped surface, such that the height of light guide 120 decreases along the length L from surface 122 (having a height=h₁) to opposite, end surface 217 (having a height=h₂, where h₂<<h₁). In one example, for mobile unit backlight applications, h₁ can be about 1 mm, the width can be about 2 mm, and L can be about 50 mm to about 150 mm.

In one aspect, top surface 123 is approximately orthogonal with respect to input surface 122 and the bottom surface 125 includes a plurality of sloping steps, with each sloping step parallel to the top surface 123. Thus, the light guide 120 can be a generally rectilinear, stepped, and sloped structure and can be formed from an optically clear material such as a polymer (e.g., polycarbonate) or glass.

Input face 122 receives light from light source unit 110. Light is passed through the anamorphic light guide 120 into a diverting portion or section 150 of the diverter/concentrator element 160. The diverting section 150 can include a plurality of diverting elements (also referred to herein as diverters) 151a-151j (see FIGS. 1E and 1F), where Each Diverting Portion Changes the Direction of the Light by approximately 90°. Each diverter includes a reflecting facet that is angled at about 30 degrees to about 60 degrees with respect to the input face. Depending on the size of optical package, the number of diverter elements can range from a few (e.g., 2-6) to 10 or more (e.g., 10 diverters are shown in the example system of FIGS. 1A-1F). In some aspects, the diverters may be packed one after the other. In other aspects, the diverters may be spaced apart from each other (e.g., a space approximate to ½ the length of the diverters may be interposed between adjacent diverters).

In one aspect, the diverting elements 151a, 151b, etc. can be integrally formed as part of the converter unit 105. The diverting elements can be positioned such that entrance faces 152a, 152b, etc. of the diverting section 150 can be disposed proximate to bottom surfaces 125a, 125b, etc of the light guide 120. Alternatively, the diverting elements 151a, 151b, etc. can be integrally formed as part of light guide 120 or they can be separately formed then attached to bottom surface 125 of the light guide 120 using an appropriate adhesive or bonding material, such as an optically clear adhesive. Please note that a portion of the light output from the light source 110 may not pass through the light guide 120 before entering the diverting section 150.

In one aspect, a unitary construction of converter unit components can be formed using compression or compression-injection molding the diverting section 150 and the light guide 120. Alternatively, a thinner version can also be manufactured using a diamond fly cutting process to cut diverter features into the edge of a stack of flat light guide films used to form light guide 120.

In one aspect, each diverter comprises a coupled or decoupled input face 152, a reflecting face 156 (e.g., faces 156a-156j, shown in FIG. 1E) that changes the light direction by approximately 90°, and guides light into a coupling section 170 of the diverter/concentrator 160. Each diverting portion is thin (relative to the size of input face 122), such that each diverter input face captures only a segment of the incoming light and reflects that light segment into coupling section 170 of the diverter/concentrator 160. For example, each diverter element can have a thickness of about 30 μm to 1000 μm, preferably about between 50 μm and 200 μm. Thus, in one aspect, each diverting element is configured as a generally planar right angle prism. As such, in one aspect, the height of the input surface 122 can be approximately equal to the sum of heights of all of the diverting structures, except that in some cases, a small segment of light passes directly from the light source 110 into the coupling portion of the diverter/concentrator element 160.

A low refractive index layer can be disposed between the anamorphic light guide 120 and the diverter portion 150. The low refractive index layer may comprise a polymer coating or a coating applied by physical vapor or chemical vapor deposition. In a preferred aspect, the low index coating will have low scatter. Suitable coatings can include silica, SiO₂, and MgF₂.

Each diverting element 151a, 151b, etc., may have a mirrored or TIR 45° facet that reflects the incoming light by about a 90° angle. Light is captured within each diverter, as the major faces of the diverter (e.g., top face 158a and bottom face 159a), are each bounded by a lower index material. For example, bottom face 159a can be bounded by air, while top face 158a can be bounded by air or by an optically clear adhesive, having a lower index (e.g., 1.49) than the index of refraction of the light guide 120. Alternatively, there may be a low index coating applied to either surface 125 or to surface 158, or both, and the surfaces coupled to each other. Similarly, surfaces 123 and 159 may be coated with a low index material to allow the material to be bonded to other elements in the display. Suitable low index coatings include silica and magnesium fluoride. In another alternative aspect, the anamorphic light guide 120 may be formed from a material with a lower refractive index than the material used to form the diverters. In yet another alternative aspect, the refractive index of the anamorphic light guide 120 may be similar to the refractive index of the diverting element, without a low index material disposed between the two, and the light guide may have a thickness less than the height h₁ of the input face of the anamorphic light guide 120, but greater than the thickness of the diverting section 150.

As shown in FIG. 1F, a first input light segment 162a is captured by diverting element 151a. The input light segment is totally internally reflected within diverting element 151a and directed off angled reflecting surface 156a towards the coupler/concentrator 170/180. The input light segment 162a emerges from the concentrator 180 as output light segment 164a. Similarly, a second light segment can be captured by diverting element 151b, which is axially spaced downstream from diverting element 151a at a height slightly offset from the height of diverting element 151a. The input light segment is totally internally reflected within diverting element 151b and directed off the angled reflecting surface towards the concentrator 180 via coupler 170. In a similar manner, each subsequent diverting element captures a segment of the input light and redirects that light segment towards the concentrator 180 via coupler 170. Thus, the output light segments 164a, etc. are coupled and at substantially collimated in at least one direction in concentrator 180 to form a shaped beam having a high aspect ratio of at least 20:1 or greater.

Reflecting surfaces 156a etc., can be flat or curved surfaces. In addition, in some aspects, the reflecting surfaces 156a etc. can be coated with a reflective coating. For example, the reflecting surfaces 156a etc. can be coated with a metal or a dielectric layered coating. Alternatively, the reflecting surfaces 156a etc. can be simply polished to totally internally reflect (TIR) light.

In construction, for converter units that comprise separately formed light guides and diverting sections, the diverting section 150 can be mated to the light guide 120 on bottom surface 125 using an optically clear adhesive or low index bonding material. In this aspect, diverting element input surface 152a can be mated with bottom step surface 125a, next diverting element input surface 152b can be mated with next bottom step surface 125b, and so forth. According to alternative aspects, the input face(s) of the diverter(s) 150 may be either optically coupled or decoupled from the light guide 120. Optically coupling the diverter can be more efficient due to reducing Fresnel reflections, but may cause losses with diverters with a 45° facet due to errant paths for the light beam. Therefore, alternatively, when utilizing diverting elements having a 45° facet, the input face may be decoupled from the light guide 120. In alternative aspects, the output face of the diverter elements may be coupled or decoupled from the input face of the coupler 170/concentrator 180.

The converter unit 105 also includes a coupling portion 170 and a concentrator portion 180. In FIGS. 1A-1F, the coupling/concentrator is formed from a single integrated construction. In alternative aspects, the coupling portion 170 and the concentrator portion 180 can be formed as separate elements within optical system 100.

Coupling portion 170 receives light exiting the diverting portion 150. As shown in more detail in FIGS. 1E and 1F, coupling portion 170 comprises a series of bodies expanding in one or more dimensions, e.g., trapezoidally-shaped coupling or coupler bodies. The bodies can have a generally planar shape (such as shown in FIGS. 1E-1F) or the coupler bodies can have a tapered shape, such as shown in FIG. 3. In some alternative aspects, the taper may be linear or the taper may be non-linear in at least one axis. A suitable non-linear profile may include a parabola. The taper feature helps capture light that passes directly through the diverter portion (without being diverted by the reflecting surface). In addition, the taper design of the coupling portion collimates the light that passes directly through the diverter portion. Light is guided within coupling portion 170 via TIR. Thus, coupling portion 170 can collimate the light in the plane of the coupling portion (i.e., in the plane parallel to the major surfaces of the coupling portion).

As mentioned above, in one aspect of the invention, coupling portion 170 can be integrally formed with diverter portion 150. In this aspect, the diverter portion 150 and coupling portion 170 may be made from a continuous molded article. Suitable materials of construction include acrylic resins, including polymethylmethacrylate (PMMA), curable acrylic resins, polystyrene, polycarbonate, polyesters, and silicones. Alternatively, coupling portion 170 can be formed using a cut strip of polymer film or by a cast and cure process.

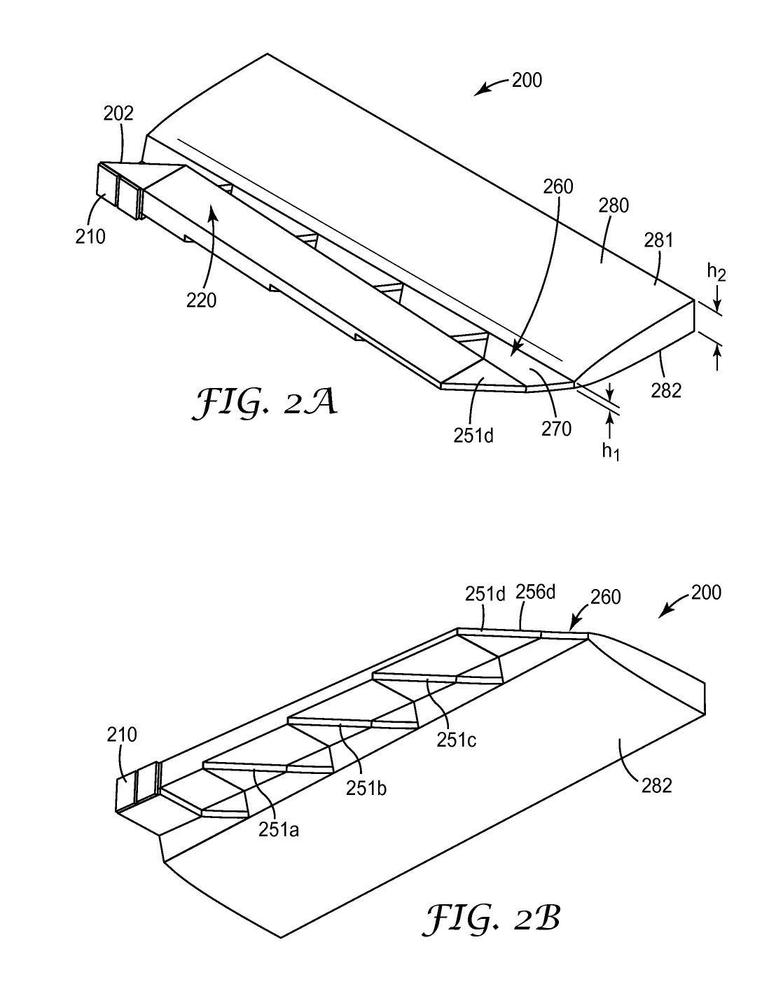

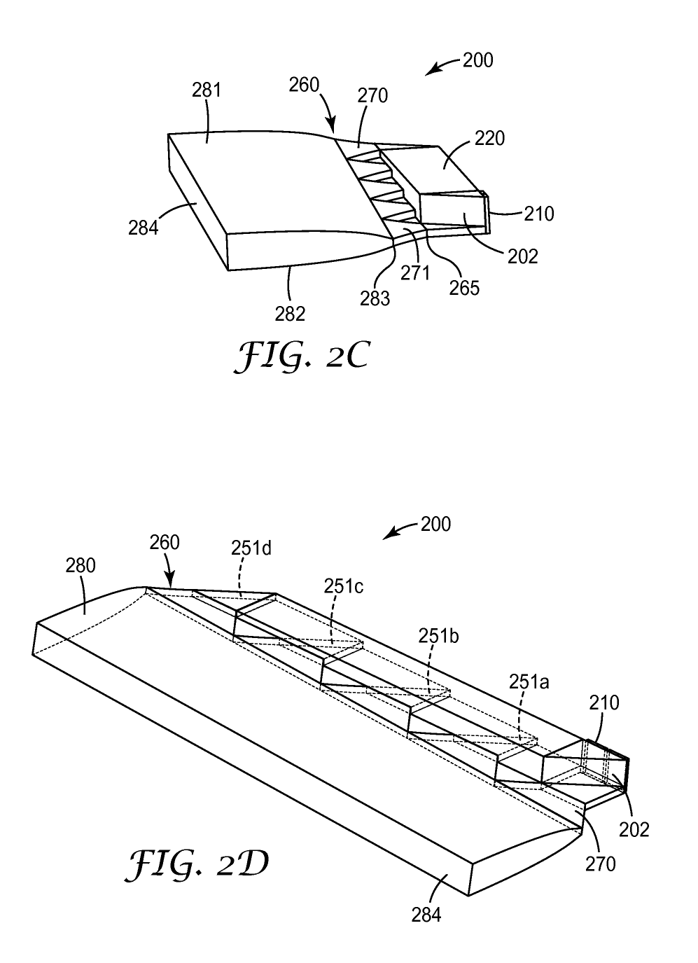

Light exiting coupling portion 170 enters concentrator portion, also referred to as concentrator 180. Concentrator 180 comprises a generally rectilinear body that can be configured to collimate light in at least one direction, e.g., normal to the plane of the concentrator 180. The concentrator 180 can smooth or diffuse out non-uniformity of the beam entering the concentrator portion. The concentrator portion 180 can have a generally planar shape (such as shown in FIGS. 1E-1F) or the concentrator 180 can have a tapered shape, such as shown in FIGS. 2A-2D. In some alternative aspects, the taper may be linear in at least one axis, the taper may be non-linear in at least one axis, or a combination of tapers may be used. A suitable non-linear profile may include a parabola. Light is guided within concentrator portion 180 via TIR. Similar to the coupling portion 170, the concentrator 180 may be made from a continuous molded article. Suitable materials of construction include acrylic resins, including polymethylmethacrylate (PMMA), curable acrylic resins, polystryrene, polycarbonate, polyesters, and silicones. As the diverter/coupling/concentrator may be formed from a molded material, the concentrator can also be shaped in such a way as to allow polymer to flow in one direction.

FIG. 1G is a partial front view of the optical package 100. Note that the diverter 150, coupling portion 170, and concentrator 180 can be slightly tilted or sloped at a small angle α of about 3° to about 12° relative to the major surface of the light guide 120, to provide for a gradual transition between adjacent diverting elements. This slope imparts a twist to the coupling section, and reduces the etendue of the system relative to one where there is no twist.

In addition, optical package 100 includes a housing 190. Housing 190 can be shaped to protect, align, support, and/or seal one or more elements of the optical system. As shown in FIG. 1B, housing 190 supports the anamorphic light guide 120 and the diverter portion 150 of the converter unit 105. In addition, the housing 190 can comprise a frame-like structure that can also provide surfaces that can be used to reflect light from the light source 110 into the anamorphic light guide 120. The housing 190 may also include structures to align the output of the concentrator 180 with a light guide or other device (not shown). Alternatively, the housing 190 can be used to allow accommodation of adjacent alignment structures (not shown).

Thus, light output from optical system 100 can have a high aspect ratio and can be utilized in a variety of applications, such as providing light for backlights and displays, especially thin backlights.

FIGS. 2A-2D show different isometric views of another exemplary optical package 200 that can be used by itself or as a module in combination with other similar optical package modules to illuminate a display (not shown) or other device. Optical package 200 includes a light source unit 210 and a converter unit that includes an anamorphic light guide 220 and diverter/concentrator unit 260 having a series of diverters 251a-251d, a coupling portion 270 and a concentrator portion 280. Please note that a housing is omitted from the figures for simplicity. Light source unit 210 provides a source of light for the optical package 200 and is disposed at one end of the optical system. In this aspect, optical package 210 includes two LEDs. In this arrangement, a reflective surface 202, which can be formed on a right angle prism or a surface of the housing (not shown), is provided to reflect at least a substantial portion of the light emitted from the light source 210 into the anamorphic light guide. In this aspect, another portion of the output light from the light source 210 may pass by the reflecting surface 202 and enter directly into the coupling body 271 of the coupling portion 270 (see e.g., FIG. 2C).

The anamorphic light guide 220 guides the light from light source unit 210 into a diverter/concentrator element 260. In this aspect, the anamorphic light guide 220 has a shorter length than anamorphic light guide 120, although the general design and structure is the same as described above. The diverter/concentrator element 260 includes a diverter portion which receives and diverts segments of the light guided by the anamorphic light guide 220 into a coupling portion 270. In this aspect, the diverter portion includes four diverters 251a-251d, each having a reflecting face 256 (e.g., face 256d is shown in FIG. 2B) that changes the light direction by approximately 90°, and guides light into a coupling section 270 of the diverter/concentrator 260. The construction of diverters 251a-251d can be similar to the construction of diverters 151a-151j described above.

Light is further directed through the coupling portion 270 into a concentrator portion 280 of the diverter/concentrator element 260. Coupling portion 270 comprises a series of coupling bodies expanding in one or more dimensions, e.g., trapezoidally-shaped bodies (such as coupling body 271 shown in FIG. 2C). The coupling bodies can have a generally planar shape with a taper in at least one direction. In this aspect, the taper is linear (expanding horizontally towards the concentrator 280). This taper feature helps capture light that passes directly through the diverter portion (without being diverted by the reflecting surface). Light is guided within coupling portion 270 via TIR. In some aspects, the coupling portion 270 can include a slight twist or angled orientation, which can improve etendue of the package 200 by a factor of two. The coupling portion can be formed from any one of the construction materials described above.

In this particular aspect, an air gap exists between the exit face of the diverter portion and the input face of the coupling portion (see e.g., interface 265 shown in FIG. 2C).

Light exiting coupling portion 270 enters concentrator portion 280. In this aspect, concentrator 280 comprises a generally rectilinear body having a taper, such that concentrator major surfaces 281 and 282 (see e.g., FIG. 2C) each have non-linear taper. In this aspect, major surfaces 281 and 282 have a parabolic taper from the entrance surface 283 towards the exit surface 284, where the concentrator has a height h₁ at the concentrator entrance and a height h₂ at the concentrator exit, where h₁<h₂. This parabolic taper can help provide collimated output light. A parabolic taper can provide a high degree of collimation in a smaller volume as compared to a linear taper. Light is guided within concentrator portion 280 via TIR. In some aspects, the concentrator portion 280 can include a slight twist or angled orientation, which can improve etendue of the package. The concentrator 280 may be made from a continuous molded article using the construction materials described above. An advantage of the design of concentrator 280 includes lateral uniformity of the output light along the major axis of concentrator 280. Concentrator 280 also provides advantages from a manufacturability standpoint.

Similar to system 100, optical package 200 efficiently couples light from the light source and provides output light with a larger aspect ratio that can be partially collimated in at least one axis. In addition, the effective height of the output light is substantially lower than the effective height of the light emitted from the light source. In some aspects, the effective height of the output light is at least a factor of five lower than the effective height of the light emitted from the light source.

For example, according to calculations performed by the investigators, using optical package 200, for LEDs having a physical height of 0.5 mm, and a FWHM angle for light parallel to the height axis of about 170°, the light output from the LEDs has an effective height of about 85 mm deg. At the output end of the optical package 200, the height of output face 284 is 0.5 mm, and the FWHM angle is about 24°, yielding an effective height of about 12 mm deg. for the optical package, a decrease of about at least a factor of seven.

Using this modular approach, a optical package designer can modify any number of different aspects of an individual optical package to provide a system tailored to meet the requirements of a particular lighting application. For example, the checked parameters shown in Table 1 below provide one example approach for creating the optical system 200 shown in FIGS. 2A-2D. Modifications of these parameters, e.g., simply by selecting or de-selecting certain parameters for each element, can be used to create a multitude of different optical packages (the optical packages 300-1100 shown in FIGS. 3-11 are just a few of the many possible alternative optical packages that can be created using this approach).

TABLE 1

| | LED | | | | |
|---|---|---|---|---|---|
| LED | COUPLING | GUIDE | DIVERTER | COUPLER | CONCENTRATOR |
| Direct | Filled | Laminate | No input edge | Planar √ | No concentrator |
| phosphor | | | | | |
| Remote | Air √ | Solid √ | Low index input | Twist | Twist √ |
| phosphor | | | edge | | |
| Direct (e.g. , | Lens | | Air space input | | In plane linear |
| RGB) | | | edge √ | | taper |
| Hybrid | CPC | | No space b/w | | In plane parabolic |
| | | | diverters | | taper |
| Side facing | 1D | | 0.5 space b/w | | Out of plane |
| emitting | | | diverters √ | | linear taper |
| direction | | | | | |
| front facing | 2D | | No coating | | Out of plane |
| emitting | | | (major face) | | parabolic taper √ |
| direction √ | | | | | |
| back facing | | | Low index | | Offset √ |
| emitting | | | (major face) | | |
| direction | | | | | |
| | | | Air spaced | | 2D not |
| | | | (major face) √ | | combined √ |
| | | | No reflector | | 2D combined |
| | | | coating | | |
| | | | Reflector | | |
| | | | coating √ | | |
| | | | Use frame | | |
| | | | No output edge | | |
| | | | Low index coated | | |
| | | | output edge | | |
| | | | Air space at | | |
| | | | output edge √ | | |

FIG. 3 shows another exemplary optical package 300 that can be used by itself or as a module in combination with other similar optical package modules to illuminate a display (not shown) or other device. Optical package 300 includes a light source unit 310 and a converter unit that includes an anamorphic light guide and diverter/concentrator unit 360 having a series of diverters, including diverter 351a, a coupling portion 370 and a concentrator portion 380. Please note that a housing is omitted from the figure for simplicity. Light source unit 310 provides a source of light for the optical package 300 and is disposed at a central location along the anamorphic light guide. In this aspect, optical package 310 includes two LEDs. In this aspect, the anamorphic light guide is divided into two parts (or smaller light guides) 320a and 320b disposed on either side of the light source 310. In this arrangement, a first reflective surface 302, which can be formed on a right angle prism or a surface of the housing (not shown), is provided to reflect at least a portion of the light emitted from the light source 310 into the anamorphic light guide 320a. A second reflective surface (not shown) can be disposed underneath first reflective surface 302, to reflect another portion of the light emitted from light source 310 into anamorphic light guide 320b. The anamorphic light guides 320a, 320b guide the light from light source unit 310 into a diverter/concentrator element 360.

In this aspect, the anamorphic light guide 320a, 320b has a shorter length than anamorphic light guide 120, although the general design and structure is the same as described above. The diverter/concentrator element 360 includes a diverter portion which receives and diverts segments of the light guided by the anamorphic light guide 320a, 320b into a coupling portion 370. In this aspect, the diverter portion includes six diverters (only diverter 351a is shown), each having a reflecting face 356 (e.g., face 356a is shown in FIG. 3) that changes the light direction by approximately 90°, and guides light into a coupling section 370 of the diverter/concentrator 360. In this aspect, the diverter portion includes a gap between adjacent diverters. This diverter spacing can provide more straightforward construction of the optical package in that this configuration provides more room for the coupling bodies at the output faces of the diverters. The construction of the diverters can be similar to the construction of diverters 151a-151j described above.

Light is further directed through the coupling portion 370 into a concentrator portion 380 of the diverter/concentrator element 360. Coupling portion 370 comprises a series of coupling bodies expanding in one or more dimensions, e.g., trapezoidally-shaped bodies (such as coupling body 371 shown in FIG. 3). In this aspect, the bodies include tapers in multiple directions, as the taper linearly expands horizontally (in plane) and parabolically expands vertically (normal to the plane of the diverter bodies) towards the concentrator 380. This taper feature helps capture light that passes directly through the diverter portion (without being diverted by the reflecting surface). Light is guided within coupling portion 370 via TIR. The coupling portion can be formed from any one of the construction materials described above. In this particular aspect, an air gap may or may not exist between the exit face of the diverter portion and the input face of the coupling portion.

Light exiting coupling portion 370 enters concentrator portion 380. In this aspect, concentrator 380 comprises a rectilinear body having no taper, such that concentrator major surfaces 381 and 382 are generally parallel with each other and generally perpendicular to output surface 384. The concentrator 380 may be made from a continuous molded article using the construction materials described above. With this configuration, the center of the light source 310 is aligned or coincident with the center of the concentrator 380 in height, thus allowing for a reduced overall package size.

FIG. 4 shows another exemplary optical package 400 that can be used by itself or as a module in combination with other similar optical package modules to illuminate a display (not shown) or other device. Optical package 400 includes a light source unit 410 and a converter unit that includes an anamorphic light guide and diverter/concentrator unit 460 having a series of diverters, including diverter 451a, a coupling portion 470 and a concentrator portion 480. Please note that a housing is omitted from the figure for simplicity. Light source unit 410 provides a source of light for the optical package 400 and is disposed at a central location along the anamorphic light guide. In this aspect, optical package 410 includes two LEDs. In this aspect, the anamorphic light guide is divided into two parts (or smaller light guides) 420a and 420b disposed on either side of the light source 410. In this arrangement, a first reflective surface 402, which can be formed on a right angle prism or a surface of the housing (not shown), is provided to reflect at least a portion of the light emitted from the light source 410 into the anamorphic light guide 420a. A second reflective surface (not shown) can be disposed underneath first reflective surface 402, to reflect another portion of the light emitted from light source 410 into anamorphic light guide 420b. The anamorphic light guides 420a, 420b guide the light from light source unit 410 into a diverter/concentrator element 460.

In this aspect, the anamorphic light guide 420a, 420b has a shorter length than anamorphic light guide 120, although the general design and structure is the same as described above. The diverter/concentrator element 460 includes a diverter portion which receives and diverts segments of the light guided by the anamorphic light guide 420a, 420b into a coupling portion 470. In this aspect, the diverter portion includes six diverters (only diverter 451a is shown), each having a reflecting face 456 (e.g., face 456a is shown in FIG. 4) that changes the light direction by approximately 90°, and guides light into a coupling section 470 of the diverter/concentrator 460. In this aspect, the diverter portion includes a gap between adjacent diverters. This diverter spacing can provide more straightforward construction of the optical package in that this configuration provides more room for the coupling bodies at the output faces of the diverters. The construction of the diverters can be similar to the construction of diverters 151a-151j described above.

Light is further directed through the coupling portion 470 into a concentrator portion 480 of the diverter/concentrator element 460. Coupling portion 470 comprises a series of coupling bodies expanding in one or more dimensions, e.g., trapezoidally-shaped bodies (such as coupling body 471 shown in FIG. 4). In this aspect, the coupling bodies are generally planar having a stepped, parabolic taper that expands horizontally towards the concentrator 480. This taper feature helps capture light that passes directly through the diverter portion (without being diverted by the reflecting surface) and collimate light in the plane of coupling portion. Light is guided within coupling portion 470 via TIR. The coupling portion can be formed from any one of the construction materials described above. In this particular aspect, an air gap may or may not exist between the exit face of the diverter portion and the input face of the coupling portion.

Light exiting coupling portion 470 enters concentrator portion 480. In this aspect, concentrator 480 comprises a generally rectilinear body having a linear taper in one direction towards output surface 484, such that concentrator major surfaces 481 and 482 are not parallel with each other. The concentrator 480 may be made from a continuous molded article using the construction materials described above. With this configuration, the center of the light source 410 is aligned or coincident with the center of the concentrator 480 in height, thus allowing for a reduced overall package size.

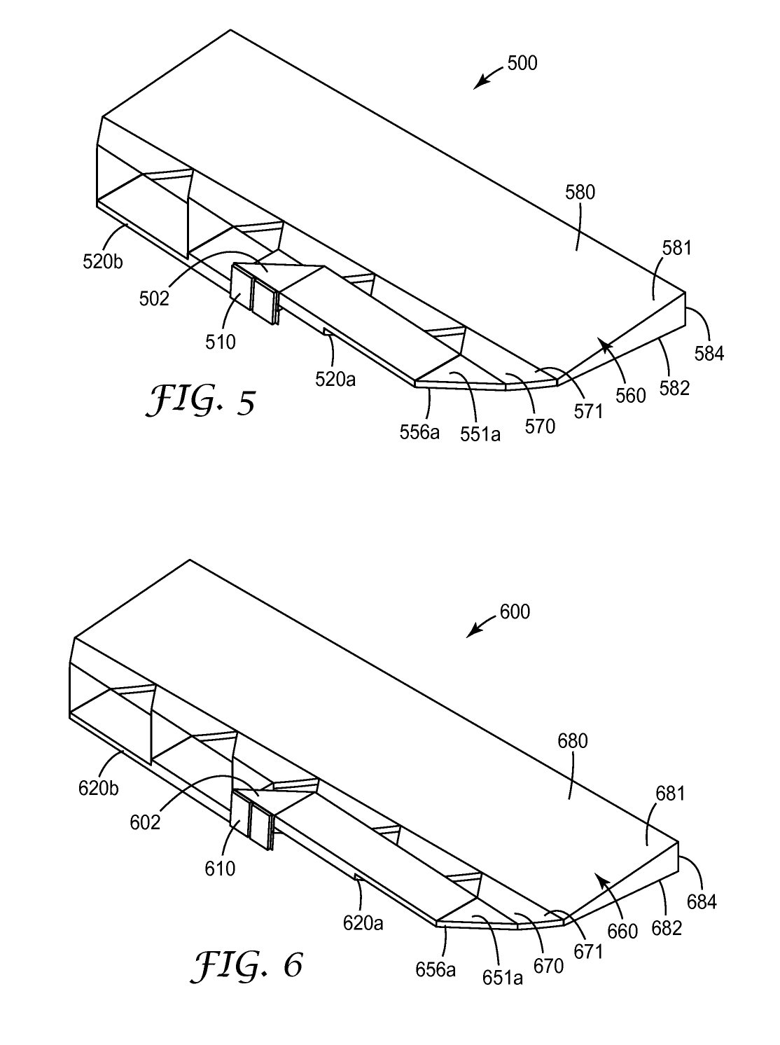

FIG. 5 shows another exemplary optical package 500 that can be used by itself or as a module in combination with other similar optical package modules to illuminate a display (not shown) or other device. Optical package 500 includes a light source unit 510 and a converter unit that includes an anamorphic light guide and diverter/concentrator unit 560 having a series of diverters, including diverter 551a, a coupling portion 570 and a concentrator portion 580. The housing is omitted from the figure for simplicity. Light source unit 510 provides a source of light for the optical package 500 and is disposed at a central location along the anamorphic light guide. In this aspect, optical package 510 includes two LEDs. In this aspect, the anamorphic light guide is divided into two parts (or smaller light guides) 520a and 520b disposed on either side of the light source 510. In this arrangement, a first reflective surface 502, which can be formed on a right angle prism or a surface of the housing (not shown), is provided to reflect at least a portion of the light emitted from the light source 510 into the anamorphic light guide 520a. A second reflective surface (not shown) can be disposed underneath first reflective surface 502, to reflect another portion of the light emitted from light source 510 into anamorphic light guide 520b. In this aspect, another portion of the output light from the light source 510 may pass by the reflecting surfaces and enter directly into a coupling body of coupling portion 570. The anamorphic light guides 520a, 520b guide the light from light source unit 510 into a diverter/concentrator element 560.

In this aspect, the anamorphic light guide 520a, 520b has a shorter length than anamorphic light guide 120, although the general design and structure is the same as described above. The diverter/concentrator element 560 includes a diverter portion which receives and diverts segments of the light guided by the anamorphic light guide 520a, 520b into a coupling portion 570. In this aspect, the diverter portion includes four diverters (only diverter 551a is shown), each having a reflecting face 556 (e.g., face 556a is shown in FIG. 5) that changes the light direction by approximately 90°, and guides light into a coupling section 570 of the diverter/concentrator 560. In this aspect, the diverter portion includes a gap between adjacent diverters. This diverter spacing can provide more straightforward construction of the optical package in that this configuration provides more room for the coupling bodies at the output faces of the diverters. The construction of the diverters can be similar to the construction of diverters 151a-151j described above.

Light is further directed through the coupling portion 570 into a concentrator portion 580 of the diverter/concentrator element 560. Coupling portion 570 comprises a series of coupling bodies expanding in one or more dimensions, e.g., trapezoidally-shaped bodies (such as coupling body 571 shown in FIG. 5). In this aspect, the coupling bodies are generally planar having a linear taper that expands horizontally towards the concentrator 580. This taper feature helps capture light that passes directly through the diverter portion (without being diverted by the reflecting surface). Light is guided within coupling portion 570 via TIR. The coupling portion can be formed from any one of the construction materials described above. In this particular aspect, an air gap may or may not exist between the exit face of the diverter portion and the input face of the coupling portion.

Light exiting coupling portion 570 enters concentrator portion 580. In this aspect, concentrator 580 comprises a generally rectilinear body having at least a linear taper in one direction towards exit surface 584, such that concentrator major surfaces 581 and 582 are not parallel with each other. In this aspect, the concentrator 580 has a relatively long length. The concentrator 580 may be made from a continuous molded article using the construction materials described above.

FIG. 6 shows another exemplary optical package 600 that can be used by itself or as a module in combination with other similar optical package modules to illuminate a display (not shown) or other device. Optical package 600 includes a light source unit 610 and a converter unit that includes an anamorphic light guide and diverter/concentrator unit 660 having a series of diverters, including diverter 651a, a coupling portion 670 and a concentrator portion 680. The housing is omitted from the figure for simplicity. Light source unit 610 provides a source of light for the optical package 600 and is disposed at a central location along the anamorphic light guide. In this aspect, optical package 610 includes two LEDs. In this aspect, the anamorphic light guide is divided into two parts (or smaller light guides) 620a and 620b disposed on either side of the light source 610. In this arrangement, a first reflective surface 602, which can be formed on a right angle prism or a surface of the housing (not shown), is provided to reflect at least a portion of the light emitted from the light source 610 into the anamorphic light guide 620a. A second reflective surface (not shown) can be disposed underneath first reflective surface 602, to reflect another portion of the light emitted from light source 610 into anamorphic light guide 620b. The anamorphic light guides 620a, 620b guide the light from light source unit 610 into a diverter/concentrator element 660.

In this aspect, the anamorphic light guide 620a, 620b has a shorter length than anamorphic light guide 120, although the general design and structure is the same as described above. The diverter/concentrator element 660 includes a diverter portion which receives and diverts segments of the light guided by the anamorphic light guide 620a, 620b into a coupling portion 670. In this aspect, the diverter portion includes six diverters (only diverter 651a is shown), each having a reflecting face 656 (e.g., face 656a is shown in FIG. 6) that changes the light direction by approximately 90°, and guides light into a coupling section 670 of the diverter/concentrator 660. In this aspect, the diverter portion includes a gap between adjacent diverters. The construction of the diverters can be similar to the construction of diverters 151a-151j described above.

Light is further directed through the coupling portion 670 into a concentrator portion 680 of the diverter/concentrator element 660. Coupling portion 670 comprises a series of coupling bodies expanding in one or more dimensions, e.g., trapezoidally-shaped bodies (such as coupling body 671 shown in FIG. 6). In this aspect, the coupling bodies are generally planar having a linear taper that expands horizontally towards the concentrator 680. This taper feature helps capture light that passes directly through the diverter portion (without being diverted by the reflecting surface). Light is guided within coupling portion 670 via TIR. The coupling portion can be formed from any one of the construction materials described above. In this particular aspect, an air gap may or may not exist between the exit face of the diverter portion and the input face of the coupling portion.

Light exiting coupling portion 670 enters concentrator portion 680. In this aspect, concentrator 680 comprises a generally rectilinear body having at least a linear taper in one direction towards exit surface 684, such that concentrator major surfaces 681 and 682 are not parallel with each other. The concentrator 680 may be made from a continuous molded article using the construction materials described above.

FIG. 7 shows another exemplary optical package 700. Optical package 700 includes a light source unit 710 and a converter unit that includes an anamorphic light guide 720 and diverter/concentrator unit 760 having a series of diverters, a coupling portion 770 and a concentrator portion 780. The housing is omitted from the figures for simplicity. Light source unit 710 provides a source of light for the optical package 700 and is disposed at one end of the optical system. In this aspect, optical package 710 includes two LEDs. In this arrangement, a reflective surface 702, which can be formed on a right angle prism or a surface of the housing (not shown), is provided to reflect at least a substantial portion of the light emitted from the light source 710 into the anamorphic light guide. In this aspect, another portion of the output light from the light source 710 may pass by the reflecting surface 702 and enter directly into the coupling portion 770.

The anamorphic light guide 720 guides the light from light source unit 710 into a diverter/concentrator element 760. In this aspect, the anamorphic light guide 720 has a shorter length than anamorphic light guide 120, although the general design and structure is the same as described above. The diverter/concentrator element 760 includes a diverter portion which receives and diverts segments of the light guided by the anamorphic light guide 720 into a coupling portion 770. In this aspect, the diverter portion includes four diverters (diverter 751a is shown in FIG. 7), each having a reflecting face 756 (e.g., face 756a is shown in FIG. 7) that changes the light direction by approximately 90°, and guides light into a coupling section 770 of the diverter/concentrator 760. The construction of the diverters can be similar to the construction of diverters described above.

Light is further directed through the coupling portion 770 into a concentrator portion 780 of the diverter/concentrator element 760. Coupling portion 770 comprises a series of coupling bodies expanding in one or more dimensions, e.g., trapezoidally-shaped bodies (such as coupling body 771 shown in FIG. 7). The coupling bodies can have a generally planar shape with a taper in at least one direction. In this aspect, the taper is linear (expanding horizontally towards the concentrator 780). Light is guided within coupling portion 770 via TIR. The coupling portion can be formed from any one of the construction materials described above.

In this particular aspect, an air gap exists between the exit face of the diverter portion and the input face of the coupling portion.

Light exiting coupling portion 770 enters concentrator portion 780. In this aspect, concentrator 780 comprises a generally rectilinear body having a linear taper in at least one direction towards exit surface 784, such that concentrator major surfaces 781 and 782 are not parallel. The concentrator 780 may be made from a continuous molded article using the construction materials described above.

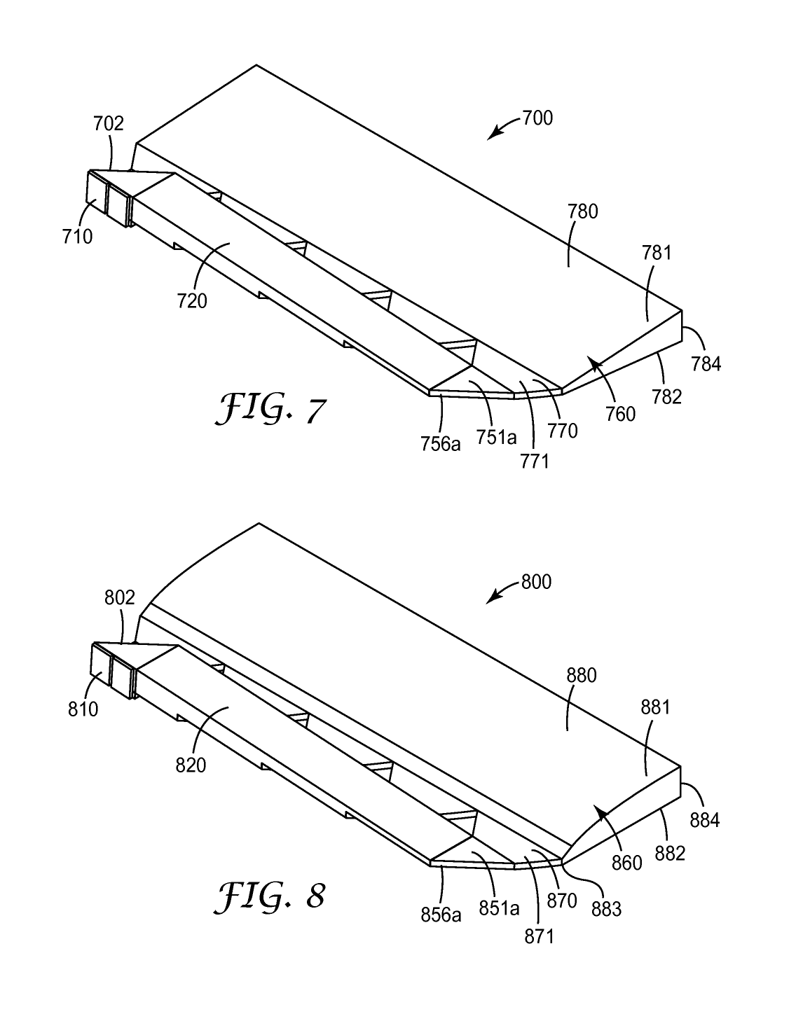

FIG. 8 shows another exemplary optical package 800. Optical package 800 includes a light source unit 810 and a converter unit that includes an anamorphic light guide 820 and diverter/concentrator unit 860 having a series of diverters, a coupling portion 870 and a concentrator portion 880. The housing is omitted from the figures for simplicity. Light source unit 810 provides a source of light for the optical package 800 and is disposed at one end of the optical system. In this aspect, optical package 810 includes two LEDs. In this arrangement, a reflective surface 802, which can be formed on a right angle prism or a surface of the housing (not shown), is provided to reflect at least a substantial portion of the light emitted from the light source 810 into the anamorphic light guide. In this aspect, another portion of the output light from the light source 810 may pass by the reflecting surface 802 and enter directly into the coupling portion 870.

The anamorphic light guide 820 guides the light from light source unit 810 into a diverter/concentrator element. In this aspect, the anamorphic light guide 820 has a shorter length than anamorphic light guide 120, although the general design and structure is the same as described above. The diverter/concentrator element 860 includes a diverter portion which receives and diverts segments of the light guided by the anamorphic light guide 820 into a coupling portion 870. In this aspect, the diverter portion includes four diverters (diverter 851a is shown in FIG. 8), each having a reflecting face 856 (e.g., face 856a is shown in FIG. 8) that changes the light direction by approximately 90°, and guides light into a coupling section 870 of the diverter/concentrator. The construction of the diverters can be similar to the construction of diverters described above.

Light is further directed through the coupling portion 870 into a concentrator portion 880 of the diverter/concentrator element 860. Coupling portion 870 comprises a series of coupling bodies expanding in one or more dimensions, e.g., trapezoidally-shaped bodies (such as coupling body 871 shown in FIG. 8). The coupling bodies can have a generally planar shape with a taper in at least one direction. In this aspect, the taper is linear (expanding horizontally towards the concentrator 880). Light is guided within coupling portion 870 via TIR. The coupling portion can be formed from any one of the construction materials described above.

In this particular aspect, an air gap exists between the exit face of the diverter portion and the input face of the coupling portion.

Light exiting coupling portion 870 enters concentrator portion 880. In this aspect, concentrator 880 comprises a generally rectilinear body having a parabolic taper in at least one direction. In this particular aspect, major surface 881 has a parabolic taper from the entrance surface 883 towards the exit surface 884, where the concentrator has a height at the concentrator exit greater than the height at the concentrator entrance. This parabolic taper helps provide collimated output light without greatly increasing the height of the exit surface 884. Light is guided within concentrator portion 880 via TIR. The concentrator 880 may be made from a continuous molded article using the construction materials described above.

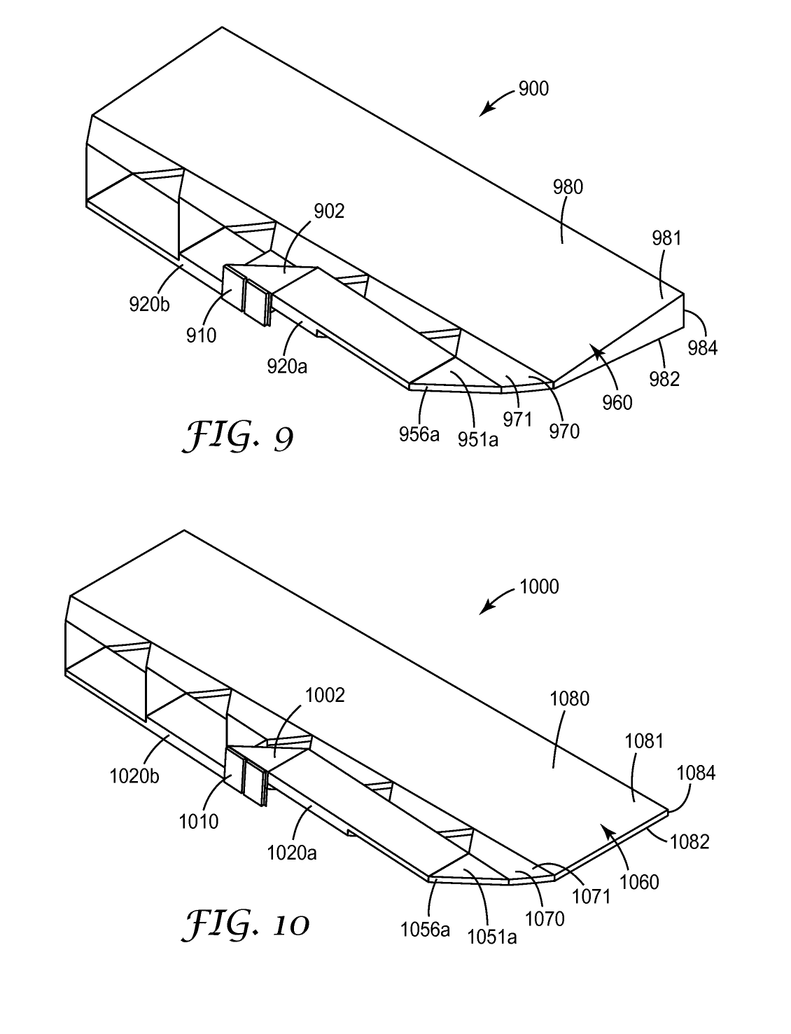

FIG. 9 shows another exemplary optical package 900. Optical package 900 includes a light source unit 910 and a converter unit that includes an anamorphic light guide and diverter/concentrator unit 960 having a series of diverters, including diverter 951a, a coupling portion 970 and a concentrator portion 980. The housing is omitted from the figure for simplicity. Light source unit 910 provides a source of light for the optical package 900 and is disposed at a central location along the anamorphic light guide. In this aspect, the anamorphic light guide is divided into two parts (or smaller light guides) 920a and 920b disposed on either side of the light source 910. In this arrangement, a first reflective surface 902, which can be formed on a right angle prism or a surface of the housing (not shown), is provided to reflect at least a portion of the light emitted from the light source 910 into the anamorphic light guide 920a. A second reflective surface (not shown) can be disposed underneath first reflective surface 902, to reflect another portion of the light emitted from light source 910 into anamorphic light guide 920b. In this aspect, another portion of the output light from the light source 910 may pass by the reflecting surfaces and enter directly into a coupling body of coupling portion 970. The anamorphic light guides 920a, 920b guide the light from light source unit 910 into a diverter/concentrator element 960.

In this aspect, the anamorphic light guide 920a, 920b has a shorter length than anamorphic light guide 120, although the general design and structure is the same as described above. The diverter/concentrator element 960 includes a diverter portion which receives and diverts segments of the light guided by the anamorphic light guide 920a, 920b into a coupling portion 970. In this aspect, the diverter portion includes four diverters (only diverter 951a is shown), each having a reflecting face 956 (e.g., face 956a is shown in FIG. 9) that changes the light direction by approximately 90°, and guides light into a coupling section 970 of the diverter/concentrator 960. In this aspect, the diverter portion includes a gap between adjacent diverters. This diverter spacing can provide more straightforward construction of the optical package in that this configuration provides more room for the coupling bodies at the output faces of the diverters. The construction of the diverters can be similar to the construction of diverters 151a-151j described above.

Light is further directed through the coupling portion 970 into a concentrator portion 980 of the diverter/concentrator element 960. Coupling portion 970 comprises a series of coupling bodies expanding in one or more dimensions, e.g., trapezoidally-shaped bodies (such as coupling body 971 shown in FIG. 9). In this aspect, the coupling bodies are generally planar having a linear taper that expands horizontally towards the concentrator 980. This taper feature helps capture light that passes directly through the diverter portion (without being diverted by the reflecting surface). Light is guided within coupling portion 970 via TIR. The coupling portion can be formed from any one of the construction materials described above. In this particular aspect, an air gap may or may not exist between the exit face of the diverter portion and the input face of the coupling portion.

Light exiting coupling portion 970 enters concentrator portion 980. In this aspect, concentrator 980 comprises a generally rectilinear body having at least one long linear taper in one direction towards exit surface 984, such that concentrator major surfaces 981 and 982 are not parallel with each other. In this aspect, the concentrator 980 has a relatively long length. The concentrator 980 may be made from a continuous molded article using the construction materials described above.

FIG. 10 shows yet another exemplary optical package 1000. Optical package 1000 includes a light source unit 1010 and a converter unit that includes an anamorphic light guide and diverter/concentrator unit 1060 having a series of diverters, including diverter 1051a, a coupling portion 1070 and a concentrator portion 1080. The housing is omitted from the figure for simplicity. Light source unit 1010 provides a source of light for the optical package 1000 and is disposed at a central location along the anamorphic light guide. In this aspect, optical package 1010 includes two LEDs. In this aspect, the anamorphic light guide is divided into two parts (or smaller light guides) 1020a and 1020b disposed on either side of the light source 1010. In this arrangement, a first reflective surface 1002, which can be formed on a right angle prism or a surface of the housing (not shown), is provided to reflect at least a portion of the light emitted from the light source 1010 into the anamorphic light guide 1020a. A second reflective surface (not shown) can be disposed underneath first reflective surface 1002, to reflect another portion of the light emitted from light source 1010 into anamorphic light guide 1020b. The anamorphic light guides 1020a, 1020b guide the light from light source unit 1010 into a diverter/concentrator element 1060.

In this aspect, the anamorphic light guide 1020a, 1020b has a shorter length than anamorphic light guide 120, although the general design and structure is the same as described above. The diverter/concentrator element 1060 includes a diverter portion which receives and diverts segments of the light guided by the anamorphic light guide 1020a, 1020b into a coupling portion 1070. In this aspect, the diverter portion includes six diverters (only diverter 1051a is shown), each having a reflecting face 1056 (e.g., face 1056a is shown in FIG. 10) that changes the light direction by approximately 90°, and guides light into a coupling section 1070 of the diverter/concentrator 1060. In this aspect, there is no gap between adjacent diverters. The construction of the diverters can be similar to the construction of diverters 151a-151j described above.

Light is further directed through the coupling portion 1070 into a concentrator portion 1080 of the diverter/concentrator element 1060. Coupling portion 1070 comprises a series of coupling bodies expanding in one or more dimensions, e.g., trapezoidally-shaped bodies (such as coupling body 1071 shown in FIG. 10). In this aspect, the coupling bodies are generally planar having a linear taper that expands horizontally towards the concentrator 1080. This taper feature helps capture light that passes directly through the diverter portion (without being diverted by the reflecting surface). Light is guided within coupling portion 1070 via TIR. The coupling portion can be formed from any one of the construction materials described above. In this particular aspect, an air gap may or may not exist between the exit face of the diverter portion and the input face of the coupling portion.

Light exiting coupling portion 1070 enters concentrator portion 1080. In this aspect, concentrator 1080 comprises a rectilinear body (no taper), such that concentrator major surfaces 1081 and 1082 are generally parallel with each other and perpendicular to exit surface 1084. In this aspect, the concentrator 1080 has a relatively long length. In addition, system 1000 has a very small height at the exit surface 1084 and only collimates light in one dimension, thereby promoting lighting/coupling with very thin display devices. As such, some configurations can yield a physical height of about 0.05 mm to about 0.2 mm. The concentrator 1080 may be made from a continuous molded article using the construction materials described above.

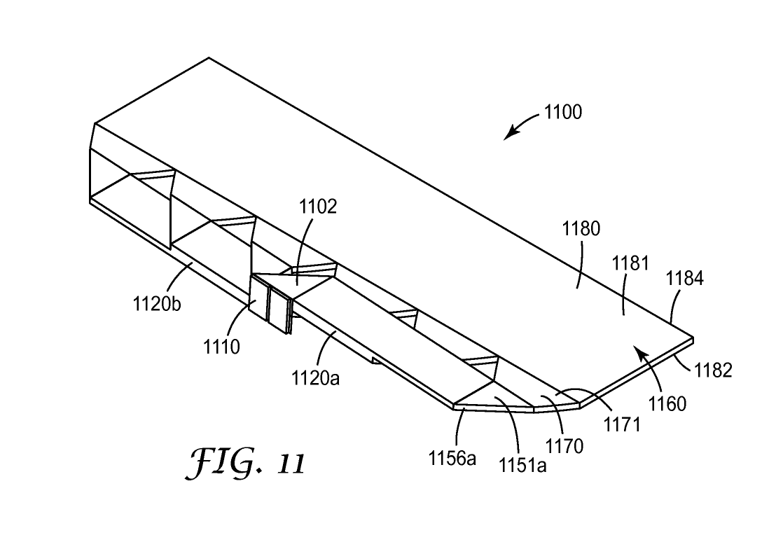

FIG. 11 shows yet another exemplary optical package 1100. Optical package 1100 includes a light source unit 1110 and a converter unit that includes an anamorphic light guide and diverter/concentrator unit 1160 having a series of diverters, including diverter 1151a, a coupling portion 1170 and a concentrator portion 1180. The housing is omitted from the figure for simplicity. Light source unit 1110 provides a source of light for the optical package 1100 and is disposed at a central location along the anamorphic light guide. In this aspect, optical package 1110 includes two LEDs. In this aspect, the anamorphic light guide is divided into two parts (or smaller light guides) 1120a and 1120b disposed on either side of the light source 1110. In this arrangement, a first reflective surface 1102, which can be formed on a right angle prism or a surface of the housing (not shown), is provided to reflect at least a portion of the light emitted from the light source 1110 into the anamorphic light guide 1120a. A second reflective surface (not shown) can be disposed underneath first reflective surface 1102, to reflect another portion of the light emitted from light source 1110 into anamorphic light guide 1120b. The anamorphic light guides 1120a, 1120b guide the light from light source unit 1110 into a diverter/concentrator element 1160.

In this aspect, the anamorphic light guide 1120a, 1120b has a shorter length than anamorphic light guide 120, although the general design and structure is the same as described above. The diverter/concentrator element 1160 includes a diverter portion which receives and diverts segments of the light guided by the anamorphic light guide 1120a, 1120b into a coupling portion 1170. In this aspect, the diverter portion includes six diverters (only diverter 1151a is shown), each having a reflecting face 1156 (e.g., face 1056a is shown in FIG. 11) that changes the light direction by approximately 90°, and guides light into a coupling section 1170 of the diverter/concentrator 1160. In this aspect, there an air gap is provided between adjacent diverters. The construction of the diverters can be similar to the construction of diverters 151a-151j described above.

Light is further directed through the coupling portion 1170 into a concentrator portion 1180 of the diverter/concentrator element 1160. Coupling portion 1170 comprises a series of coupling bodies expanding in one or more dimensions, e.g., trapezoidally-shaped bodies (such as coupling body 1171 shown in FIG. 11). In this aspect, the coupling bodies are generally planar having a linear taper that expands horizontally towards the concentrator 1180. This taper feature helps capture light that passes directly through the diverter portion (without being diverted by the reflecting surface). Light is guided within coupling portion 1170 via TIR. The coupling portion can be formed from any one of the construction materials described above. In this particular aspect, an air gap may or may not exist between the exit face of the diverter portion and the input face of the coupling portion.

Light exiting coupling portion 1170 enters concentrator portion 1180. In this aspect, concentrator 1180 comprises a rectilinear body (no taper), such that concentrator major surfaces 1181 and 1182 are generally parallel with each other and perpendicular to exit surface 1184. In this aspect, the concentrator 1180 has a relatively long length. In addition, system 1100 has a very small height at the exit surface 1184 and only collimates light in one dimension, thereby promoting lighting/coupling with very thin display devices. Such a configuration can yield a physical height of about 0.05 mm to about 0.2 mm. The concentrator 1180 may be made from a continuous molded article using the construction materials described above.

Thus, the optical package and components thereof described above provide an efficient lighting system for a display. For example, a display can be illuminated by one, two, three, or more separate optical package modules (including any of optical packages 100-1100). The modules can be arranged end-to-end on the same side of a display device or on different sides of the display device. The modules can be the same or different configurations within a single display device. The optical package and its components, taken together or separately provide a highly modular, efficient lighting system with low etendue and a reduced number of overall components. The optical packages described herein can couple to even thinner display devices than conventional backlight systems.

Although specific embodiments have been illustrated and described herein for purposes of description of the preferred embodiment, it will be appreciated by those of ordinary skill in the art that a wide variety of alternate or equivalent implementations may be substituted for the specific embodiments shown and described without departing from the scope of the present invention. Those with skill in the art will readily appreciate that the present invention may be implemented in a very wide variety of embodiments. This application is intended to cover any adaptations or variations of the embodiments discussed herein.

1. An optical package, comprising:
a light source generating light having a first aspect ratio; and
a converter unit that includes an anamorphic light guide to receive the light from the light source, a diverter array to receive and divert light from the anamorphic light guide, and a concentrator to collect light received from the diverter array, wherein the concentrator outputs light having a second aspect ratio, the second aspect ratio being greater than the first aspect ratio, and wherein an effective height of the output light from the concentrator is lower than an effective height of the light emitted by the light source.

2. The optical package of claim 1, where the diverter array and concentrator are formed as part of a diverter/concentrator element that further includes a coupling portion disposed between the diverter array and concentrator.

3. The optical package of claim 1, wherein the effective height of the light output from the concentrator is substantially lower than the effective height of the light emitted from the light source.

4. The optical package of claim 1, wherein light entering the input face of the anamorphic light guide has an aspect ratio of about from about 1 to 1 to about 1 to 4 and the light exiting the output face has an aspect ratio of at least 1 to 25.

5. The optical package of claim 1, wherein the light diverting portion comprises an array of spatially separated diverting elements.

6. The optical package of claim 1, wherein each diverting element comprises a substantially reflecting facet that substantially reflects light.

7. The optical package of claim 1, wherein each diverting element includes a mirrored or TIR 45° facet that reflects the incoming light by about a 90° angle.

8-9. (canceled)

10. The optical package of claim 1, wherein each spatially separated diverting element has an upper major surface and a lower major surface bounded by a lower index material.

11. (canceled)

12. The optical package of claim 1, wherein the anamorphic light guide is formed from a generally rectilinear structure having a first major surface and second major surface, at least one of the major surfaces being a stepped surface.

13. The optical package of claim 12, wherein stepped surface comprises a plurality of step structures each having a step height from about 20 μm to about 80 μm.

14. The optical package of claim 12, wherein the light diverting portion comprises an array of spatially separated diverting elements mated with the stepped surface.

15. The optical package of claim 14, wherein an optically clear adhesive is disposed between the stepped surface and the light diverting portion.

16. (canceled)

17. The optical package of claim 1, wherein the coupling portion and concentrator portion are formed from a single integrated construction.

18-24. (canceled)

25. The optical package of claim 1, wherein the concentrator is configured to collimate light in at least one direction.

26-32. (canceled)

33. The optical package of claim 1, further comprising a housing to protect and support one or more elements of the optical package.

34. The optical package of claim 33, wherein the housing includes a frame having a reflecting surface configured to direct light output from the light source into the anamorphic light guide.

35-38. (canceled)

39. The optical package of claim 1, wherein the light source comprises first and second LEDs, wherein the output wavelength of the first LED is different from the output wavelength of the second LED.

40. The optical package of claim 1, wherein the effective height of the output light from the concentrator is at least a factor of five lower than an effective height of the light emitted by the light source.

41. (canceled)

42. A display device comprising the optical package of claim 1.

43-44. (canceled)

45. An optical package, comprising:
a light source generating light having a first aspect ratio; and
a converter unit that includes an anamorphic light guide to receive the light from the light source, a diverter array to receive and divert light from the anamorphic light guide, and a concentrator to collect light received from the diverter array, wherein the concentrator outputs light having a second aspect ratio, the second aspect ratio being greater than the first aspect ratio, wherein a physical height of the output light is lower than a physical height of the light source.
